(19) United States
(12) Patent Application Publication
(10) Pub. No.: US 2003/0090362 A1
(43) Pub. Date: May 15, 2003

(54) Remote controller with energy saving

(76) Inventor: Michael Dennis Hardwick, Dorchester (GB)

Correspondence Address: Richard M Goldberg, Suite 419, 25 East Salem Street, Hackensack, NJ, 07601, US

(21) Appl. No.: 10/258,330

(22) PCT Filed: Apr. 19, 2001
(86) PCT No.: PCT/GB01/01777

(30) Foreign Application Priority Data
Apr. 25, 2000 (GB) 0009962.2
Feb. 19, 2001 (GB) 0104000.5

(51) Int. Cl. G05B 19/42

(52) U.S. Cl. 340/5.1; 340/310.08

(57) ABSTRACT

Energy consumption of a building is reduced by switching electrical apparatus (10) thereof off when not required. An intruder alarm (14) serves to register whether the building is open or closed by being alternatively disarmed and armed. A controller (22) transmits a control signal over the mains supply (20) whenever the alarm (14) is disarmed or armed. This signal is picked up by a remote receiver (24) which causes a relay (26) to close or open, alternatively connecting and disconnecting the apparatus (10) to the mains (20) according to whether the building is open or closed. Manual control is provided by a telephony or other connection TT to the controller (22). The alarm (14) may be replaced or supplemented by a lock or other means to register the state of the building, and radio signalling may be employed instead of mains signalling. The system may be used domestically.

This invention concerns the control of electrical apparatus remotely, especially but not exclusively for reducing the power consumed thereby.

Many premises, such as factories, shops and offices, contain electrical apparatus which needs to be on for only a portion of each day. A cold drinks dispenser in a factory, for instance, needs to be on (cooling the drinks it contains) during the hours when the factory is in an open state—that is, when staff are working on the premises; but such a cold drinks dispenser does not need to be on when the factory is in a closed state—that is, when it is unoccupied, say at night. The same applies, of course, to hot drinks dispensers and a wide range of other apparatus including air conditioning units, space heaters, water heaters, fans, lights and so forth.

Energy and costs are saved if such Items of apparatus are switched off when not required. Two known ways of doing this are (a) to appoint somebody to go around the premises and switch the apparatus on and off as appropriate and (b) to connect the apparatus to the power supply by means of time switches. Both of these approaches have problems, as will now be explained.

Appointing somebody to switch the apparatus on and off may be relatively expensive, especially if the person appointed is of a management grade (it being currently common in business for senior staff to be first to arrive and last to leave). It draws that person away from normal duties, which is contrary to good management practice. It calls for additional organisation, particularly in covering for sickness and holidays. And it presents a practical problem in that many kinds of apparatus such as drinks dispensers are deliberately arranged to shield access to their connections with the power supply, for safety and to deter tampering. Finally, the person appointed may become neglectful of the task over time, especially if nobody else notices whether or not the task is being properly performed.

The problems outlined above in relation to manual switching may be overcome by the use of time switches, but at the cost of introducing other problems. First, time switches inherently work on a routine, changing from on to off at set times of the day, and thus they do not offer any flexibility with regard to use of premises: they do not, for instance, adapt to early opening or late closing. In any event, time switches need to be reset twice a year, when clocks are seasonally adjusted. Also, unless the time switch is sophisticated enough (and therefore expensive) to be programmable for a whole week, it will treat weekends and holidays as normal working days and an appliance connected to it will be switched on even though the premises are closed.

The various problems of manual switching and time switching may be addressed by remote control systems, and a large number of such systems, using a range of signalling media are previously known. For instance, United Kingdom patent application 2 325 070 A discloses a lighting control system operated by a hand-held control unit transmitting infra-red, ultrasound, microwave or radio signals; European patent application 0 255 580 A2 also discloses a lighting control system operated by a remote control device, in this case with different control signals to control different lights; United Kingdom patent application 2 036 462 A discloses an electrical socket outlet incorporating a control unit responsive to control signals to switch the socket on; and United Kingdom patent application 2 032 664 A discloses a switch for an electrical appliance actuated remotely by mains signalling. Other remote control systems are disclosed in GB 2 322 214 A, GB 2 060 964 A, EP 0 089 641 A1, EP 0 031 874 A1 and WO 95/02231 A1.

In none of these prior systems noted above is switching controlled by registering the open or closed state of the building, which is an object of the present invention. Further, none of these prior systems is specifically concerned with energy saving.

According to a first aspect of the invention there is provided a system for controlling electrical apparatus remotely, which system comprises register means for registering whether a building containing the apparatus is in an open state or a closed state, a controller operatively associated with the register means to transmit a control signal representing said state of the building, and a receiver remote from the controller for receiving the control signal, wherein the receiver includes a switch operable by the control signal to switch the apparatus on and off alternatively according to whether the control signal represents the open or the closed state of the building.

The invention offers energy saving by switching controlled apparatus off when the building is closed. Thus, for instance, a cold drinks dispenser in a factory under the control of the invention will be turned off when the factory is closed. Those skilled in the art will appreciate that certain apparatus, such as stand-by lights, may by means of the invention be turned on when the building is closed.

Preferably the controller transmits the control signal automatically whenever the building is vacated and reentered. This may be done by incorporating the register means in or associating the register means with some means of controlling access to the building, such as an intruder alarm or a lock for the building.

Preferably, also, the controller transmits the control signal repetitively when the building is in its open or its closed state. This combats any spurious signals which might interfere with the proper operation of the switch.

The controller may be manually operable, and it may be portable.

The control signal may be a radio signal of an approved frequency such (in the United Kingdom) in the 433 MHz band. The control signal is preferably encoded, which has a number of benefits: it guards against malfunctions from unauthorised operation or extraneous spurious signals; it improves reliability, by allowing received signals to be checked; it allows the system to be differentiated from any other similar system in the vicinity; and it allows the system to be partitioned, allowing different appliances to be turned on and off separately.

According to a second aspect of the invention there is provided a method of saving energy by switching electrical apparatus of a building off when the building is in a closed state and on when the building is in an open state, or vice versa, which method comprises registering the state of the building, transmitting a control signal representing the registered state and remotely switching said apparatus on and off in response to the control signal.

The apparatus is preferably switched automatically when the control signal changes between representing the open state and representing the closed state. The control signal is preferably transmitted repetitively as long as the registered state is unchanged.

The invention will now be described by way of example only with reference to the accompanying schematic drawings in which

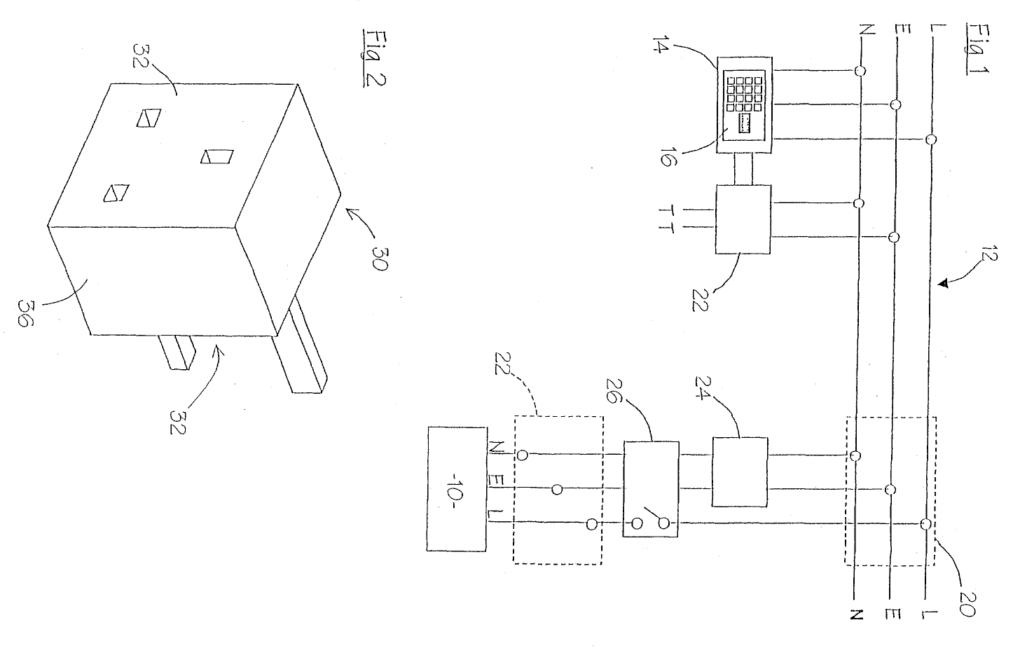

FIG. 1 is a diagrammatic representation of a first embodiment of a system for controlling powered apparatus remotely according to the invention;

FIG. 2 is a representation in isometric projection of an electrical adapter unit of the first embodiment of the system;

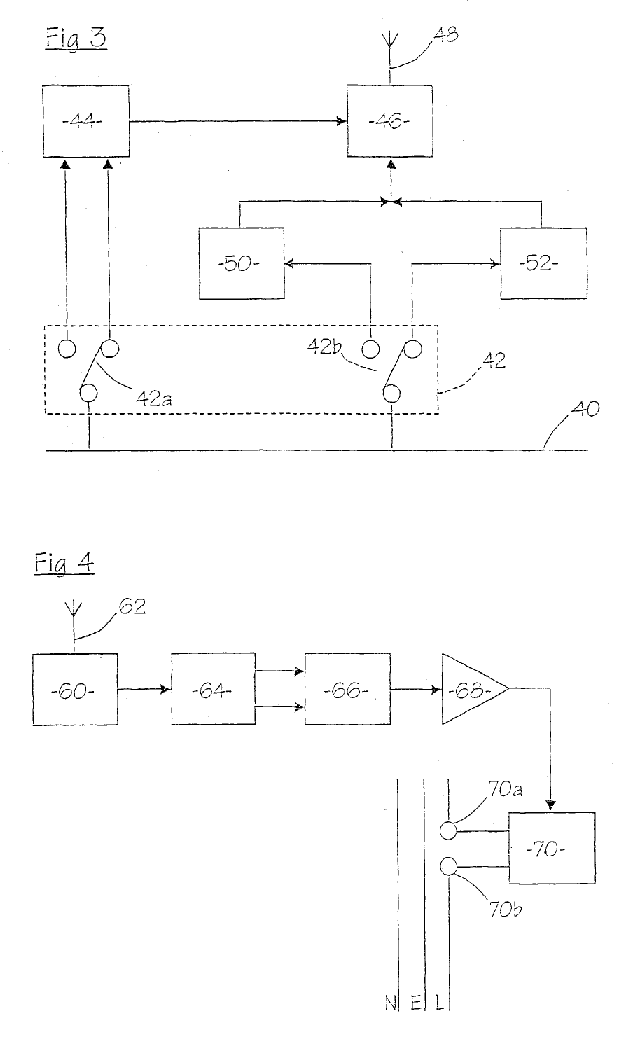

FIG. 3 is a block diagram of a controller of a second embodiment of a system for controlling electrically powered appliances remotely according to the invention; and

FIG. 4 is a block diagram of switching means of the second embodiment of the system.

FIG. 1

Referring first to FIG. 1, this shows a cold drinks dispenser 10 of the kind typically provided in a building such as an office or factory for the convenience of staff. The drinks dispenser 10 is powered from a conventional electrical power supply indicated in part at 12 and comprising live (L), earth (E) and neutral (N) wires. Other powered apparatus, not shown for simplicity, may of course be connected to the power supply.

Also powered from the same power supply is an intruder alarm system of which the control box is shown at 14. The alarm system is of conventional form and its detailed design does not form part of the present invention. The alarm system control box 14 is provided in well known fashion with a keypad 16 whereby a secret number may be keyed in and including an ENTER key for confirming the number and thereby alternatively arming and disarming the alarm system. Naturally, the alarm system is armed while the building is closed and disarmed while it is closed. Thus the alarm system effectively registers the (open or closed) state of the building.

As well as the usual array of sensors (omitted from the drawing for the sake of simplicity) a tone generator 18 is connected to the alarm system at the control box 16 in such a way that a tone is generated when the alarm system changes state from armed to disarmed and vice versa. The tone generator 18 is connected to the E and N wires of the power supply 12 so that the tones generated are transmitted over this pair of wires.

As shown in FIG. 1 the drinks dispenser 10 is connected to the power supply 12 by a receiver which, as will hereinafter be described, responds to the tones transmitted over the earth and neutral wires of the circuit 12. The receiver comprises first connection means 20 engaged with the L, E and N wires, second connection means 22 engaged with the L, E and N wires of the drinks dispenser 10, a tone detector 24 connected to the E and N pins of the first connection means 20 and a relay 26 connected to the tone detector 24. The relay 26 is operable to make and break the L path from the first connection means 20 to the second connection means 22. When a tone from the tone generator 18 is transmitted over the E and N wires of the power supply 12, it is detected by the tone detector 24 of the receiver and this in turn causes the relay 26 to change from make to break or vice versa.

The drinks dispenser 10 is required to be on whenever the building is open, so during this time the L path to the dispenser 10 is made. When the building is to close, the last task before it is vacated is to arm the intruder alarm system by means of the control box 14. As the alarm system is armed (say, when the ENTER key is depressed) a tone representing the closed state of the building is generated by the tone generator 18. This tone is transmitted over the E and N wires of the power supply 12, where it is detected by the tone detector 24. This changes the relay 26 from make to break, cutting off power from the drinks dispenser 10. Thus the dispenser 10 is off when the building is closed.

When the building is reentered (which may be the next morning or at some other time eg after a weekend or holiday) the first task is to disarm the intruder alarm system by means of the control box 14. Again, as the alarm system is disarmed, a tone representing the open state of the building is transmitted and received, the relay 26 returns from break to make and the drinks dispenser 10 is turned on again.

In this way the drinks dispenser is on, and consuming power, only when the building is open, with a consequent saving of electricity and cost. It will be noted that the power supply 12 as a whole is not switched off but remains substantially constant even while the building is closed. Thus the intruder alarm (and any other apparatus requiring continuing power from the supply) remains on.

A number of proprietory tone generators and tone detectors are available for use in the invention, and an economical approach is to use dual-tone multifrequency (DTMF) chips which are used on a very large scale in telecommunications, such as the National Semiconductor 53130 tone generator and the Mostek 5102(N)-5 tone detector. DTMF provides for a first pair of frequencies to signal a change from closed to open and a second pair of frequencies to signal a change from open to closed. The use of two signals in this way, the first to make the relay connection and the second to break it, is better than a single signal driving the relay alternately one way and then the other because it guards against the possibility of the power control system becoming (eg through a false signal) out of step with the alarm system. An additional preferred safeguard is to provide means for transmitting a control signal under manual control, to allow the system of FIG. 1 to be set and reset independently of the intruder alarm system. This may be done by means of a telephony connection T,T to the tone generator 22 and/or by an override button or switch operatively connected to the tone generator 22 or possibly by signalling through the power supply network. In this way a member of staff may, among other things, switch certain apparatus on or off remotely. Those skilled in the art will appreciate that other kinds of mains signalling technique may be used in the invention.

Whilst the embodiment of FIG. 1 has been described as having a control signals transmitted whenever an intruder alarm system is armed or disarmed, it will be understood that this may be done in other ways. An alternative way of registering whether the building is open or closed, for instance, would be to connect the signal generator to a lock of the building.

FIG. 2

As shown in FIG. 2 the receiver of the power control system of FIG. 1 may conveniently be incorporated in an electrical adapter unit 30 providing a three-pin plug fitment 32 on one side and a three-pin socket fitment 34 on the other side. In use the plug fitment 32 of the adapter unit 30 is plugged into a socket outlet (not shown) of a power supply such as 12 (FIG. 1), forming first connection means 20. A plug (not shown) on the power cord of apparatus such as drinks dispenser 10 is plugged into the socket fitment 34 of the adapter unit 30, forming second connection means 22. A tone detector 24 and a relay 26 are connected between plug 32 and socket 26 in the manner shown in FIG. 1 but not visible in FIG. 2, being enclosed by the casing 36 of the adapter unit 30.

The adapter unit 30 provides means whereby any powered apparatus such as the drinks dispenser of FIG. 1 may be switched off when not required. Neither the power supply nor the apparatus itself needs to be modified, although it should be noted that this arrangement calls for precautions against fire or other hazards which may arise if certain appliances are turned on remotely without a responsible person present. A plurality of pieces of apparatus may be served from a common power supply by way of individual adapter units 30. Further, by selectively setting the tone detectors to respond to different signals, commonly served pieces of apparatus may be switched on and off differentially as required.

Instead of tones transmitted over mains wiring as described above with reference to FIGS. 1 and 2, a second embodiment of the invention is controlled by way of radio signals, as will now be described (including certain additional features) with reference to FIGS. 3 and 4.

FIG. 3

FIG. 3 illustrates a controller of the second embodiment. A supply voltage is delivered (from a mains supply by way of a transformer, not shown for simplicity) from a line 40 to both parts 42a and 42b of a two-part, two-position key-switch shown in broken lines at 42. The key-switch 42 is located at a convenient position, eg adjacent the front door of a building containing the system, and it is manually operable by means of a key (not shown) which is removable to guard against unauthorised operation. The key-switch 42 is connected by way of part 42a to an encoder 44 and thence to a first input of a radio transmitter 46 having an antenna 48. The key-switch 42 is also connected, by way of part 42b, to a pair of timers 50 and 52 arranged in parallel, and thence to a second input of the radio transmitter 46. The radio transmitter operates at 433 Mhz which, in the United Kingdom at least, is a frequency band permitted for this use and for which proprietary transmitter and receiver modules are readily available.

When the key-switch 42 is set (by means of its key) in a first of its two positions, the encoder 44 generates a signal representing OPEN for transmission by the transmitter 46. As long as the key-switch 42 stays in this first position the timer 50, which is energised by part 42b in the first position of the key-switch 42, causes the transmitter 46 to transmit the OPEN signal as a 1s burst every 150s. Similarly, when the key-switch 42 in the second of its torso positions, the encoder 44 generates a signal representing CLOSED for transmission by the transmitter 46, and as long as the key-switch 42 stays in this second position the timer 52, which is similar to the timer 50 but energised by part 42b when the key-switch 42 is in its second position, causes the transmitter 46 to transmit the CLOSED signal as a 1s burst every 150s. Whenever the key-switch 42 is reset, ie changed by means of its key from its first position to its second position or vice versa, the newly energised timer 50 or 52 triggers an immediate 1s burst of transmission from the transmitter 46, signalling a change between OPEN and CLOSED.

It will thus be understood that the key-switch 42 registers the state of the building (like, or additional to, the intruder alarm and building lock hereinbefore described with reference to FIG. 1). The controller of FIG. 3 signals a change of state of the building as soon as the key-switch 42 is reset and, as is described in more detail below, the system switches apparatus connected to it on or off at once. A burst of 1s is long enough to distinguish the control signal from extraneous noise or other transmissions, so the system switches reliably. And the repetition of the control signal at 150s intervals cancels any spurious signals, so the system is protected against an incorrect setting.

FIG. 4

FIG. 4 illustrates the receiver of the second embodiment of the invention. The receiver of FIG. 4 includes a radio receiver 60, with antenna 62, tuned to receive a control signal transmitted (in 1s bursts) from the transmitter 46 of FIG. 3. The radio receiver 60 passes these control signals to a decoder 64 which determines whether each such signal represents OPEN or CLOSED and triggers a flip-flop 66 accordingly. The flip-flop 66 has two alternative states corresponding respectively to OPEN and CLOSED and includes a latching circuit (not detailed, but of well known form) so that it stays in one state or the other until it receives a contrary signal from the decoder 64. The flip-flop 66 has an output which is thereby latched and this output is amplified by an amplifier 68 to drive a relay 70. The relay has contacts 70a and 70b in the live wire L of the power supply to apparatus (not shown) such as a cold drinks machine.

The invention can be applied to any apparatus which needs to be switched on and off according to the state of a building including, as well as the cold drinks dispenser referred to, hot drinks dispensers, water heaters, space heaters, fans, air conditioning units and lights. With regard to lights, the system may turn security lights on when a building is closed, as well as turning main lights off. Lights and some other items may be turned to a low or stand-by setting rather than being turned off completely when a building is closed. For instance, during cold weather a space heater in a building may be required to operate at a high level for staff comfort when the building is open, but operation at a low level (enough to prevent freezing, say) may be adequate when the building is closed. The invention may be arranged to effect switching between such high and low levels, and for the avoidance of doubt references herein to switching apparatus “on” and “off” are to be construed accordingly.

Various modifications and adaptations of the system as described may be made without departing from the essence of the invention. For example, the controller of FIG. 3 may be portable and battery-powered, rather than as described. This offers benefits in both large scale and small scale applications. On a large site one person, such as a security guard on his rounds, can control appliances in a number of buildings. And on a small scale, for domestic application a householder may carry a portable controller and use it to switch on house lights when arriving home, or if disturbed at night.

The receiver of FIG. 4 may be incorporated in an adapter unit similar to that shown in FIG. 2, or in an electrical plug of the apparatus to be controlled (which reduces the likelihood of the receiver's being lost or stolen). Those skilled in the art will appreciate that a number of appliances equipped with such adapters or plugs may be dispersed around a building to be switched on and off together by means of a single, conveniently located controller. The receiver of FIG. 4 may otherwise be contained within an electrical socket rather than in a plug, whereby whatever is plugged into that socket may be remotely controlled. As another possible modification, the receiver of FIG. 4 may be partitioned so that, say, the relay 70 and its contacts are in a plug and the rest of the receiver in a socket, interconnected by way of the earth or neutral, whereby remote switching would be available only through the plug and corresponding socket.

Finally, similar to the facility T,T or the like permitting the system of FIG. 1 to be reset manually, the system of FIGS. 3 and 4 may be provided with a manual override control separate from the controller, whereby equipment controlled by the system may be turned on independently of the controller. An example of the benefit of this is as follows. Consider the use of the system in a military barracks having a number of accommodation blocks for troops. Each block is provided with a manual override button, near its entrance, operable to switch on controlled apparatus in that block independently of the registered state of the block. If the troops go away, say on a tour of duty, the system registers the empty blocks and turns off unnecessary apparatus therein, without anybody having to enter the essentially private accommodation. When the troops return to any block, all they have to do is press the manual override button to turn the apparatus in that block back on.

1. A system for controlling electrical apparatus remotely to reduce power consumed thereby, which system comprises:
register means for registering whether a building containing the apparatus is in an open state or close state;
a controller operatively associated with the register means to transmit a control signal representing said state of the building; and
a receiver remote from the controller for receiving the control signal, wherein the receiver includes a switch operable by the control signal to switch the apparatus on and off alternatively according to whether the control signal represents the open or the closed state of the building.

2. A system for controlling electrical apparatus remotely as claimed in claim 1, wherein the controller transmits the control signal automatically whenever the building is vacated and reentered.

3. A system for controlling electrical apparatus remotely as claimed in claim 1 or claim 2, wherein the controller transmits the control signal repetitively when the building is in its open or its closed state.

4. A system for controlling electrical apparatus remotely as claimed in any preceding claim, wherein the register means comprises an intruder alarm for the building.

5. A system for controlling electrical apparatus remotely as claimed in any preceding claim wherein the register means comprises a lock for the building.

6. A system for controlling electrical apparatus remotely as claimed in any preceding claim, wherein the controller is manually operable.

7. A system for controlling electrical apparatus remotely as claimed in claim 6, wherein the controller is portable.

8. A system for controlling electrical apparatus remotely as claimed in any preceding claim, wherein the control signal is a radio signal in the 433 MHz band.

9. A system for controlling electrical apparatus remotely as claimed in any preceding claim, wherein the receiver is embodied in an electrical socket and/or an electrical plug for the apparatus.

10. A system for controlling electrical apparatus remotely as claimed in any preceding claim, wherein the control signal is encoded.

11. A system for controlling electrical apparatus remotely as claimed in any preceding claim, including means separate from the controller for manually overriding the control thereof.

12. A system for controlling electrical apparatus to reduce power consumed thereby substantially as hereinbefore described with reference to and as shown in the accompanying drawings.
